(19) United States
(12) Patent Application Publication
(10) Pub. No.: US 2006/0251355 A1
(43) Pub. Date: Nov. 9, 2006

(54) Photoelectric chip array package structure

(76) Inventors: Bily Wang, Hsin Chu City (TW); John Lin, Chiai Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/416,163

(22) Filed: May 3, 2006

(30) Foreign Application Priority Data
May 6, 2005 (TW) 94207368

(51) Int. Cl. G02B 6/12

(52) U.S. Cl. 385/14

(57) ABSTRACT

A photoelectric chip array package structure is convenient for chip installation and prevents external light interference. The photoelectric chip array package structure of the present invention has a substrate, multiple photoelectric chips, a package structure, and multiple contacts. It can be applied for advertising signs and improve the defect-free ratio and packaging quality. When applied for packaging light-emitting diodes (LEDs) or optical sensors, it easily meets the packaging requirements of electronic chips. The present invention disposes contacts at one side or multiple predetermined sides of the substrate to improve airtightness and convenience for installation. In addition, the present invention also disposes an external frame or optical gratings to prevent external light interference. Thus, the package structure of the present invention is superior to conventional package structures, and is cheap.

### BACKGROUND OF THE INVENTION

1. Field of the Invention

The present invention is related to a photoelectric chip array package structure, and more particularly, to a package structure having semiconductor components or illuminant components. The package structure of the present invention is robust and can prevent interference of external light. Contacts for connecting external circuits are disposed at one side of the package body to improve convenience of installation. An external frame is provided to prevent the external light interference. In this way, the photoelectric chip array package structure provided in the present invention is superior to conventional ones.

2. Description of Related Art

Semiconductor packaging is a consistently important aspect of semiconductor manufacturing. However, since electronic products are required to be light, thin, short, small and multifunctional, light-emitting diode (LED) and optical sensor packaging industries are also rapidly growing nowadays. The importance of the LED and optical sensor packaging industries has become almost the same as that of the semiconductor packaging industry. The LED or semiconductor packaging industry unceasingly provides new techniques, such as the ball grid array (BGA) for photoelectric chip array packaging, that meet the requirements of surface mount technology (SMT). In particular, a superior substrate is needed when the number of pins is large. Meanwhile, the brightness of packaged products is also very important.

Electronic packaging technology concerns a manufacturing process used to install semiconductor integrated circuits (ICs) or LEDs together with other electronic components into an electrical connecting frame to form an electronic product, and thereby provide a specific function. An electronic package mainly has four purposes, power distribution, signal distribution, heat dissipation, and provision of protection and support. Commonly used electronic packages are an IC chip package and an LED package.

Reference is made to FIG. 1, which shows a conventional photoelectric chip array package structure. A substrate 10a is attached with multiple photoelectric chips 40a. The photoelectric chips 40a are connected to the internal circuit of the substrate 10a. A package structure is provided to package the photoelectric chips 40a with an adhesive material.

When the conventional photoelectric chip array package structure is installed on a printed circuit board (PCB), the costly BGA mount technology must be used. The conventional photoelectric chip array package structure further has problems of brightness and too many contacts. If the weld of the BGA contacts are not carefully controlled, the substrate may be twisted by the adhesion force, particularly when the substrate is too thin. In practice, the situation affects precision and reduces the defect-free ratio. Accordingly, for most of the LEDs that need substrates in the market, airtightness, convenience for installation and structural robustness are highly required in the packaging process. Enhancement of light intensity and prevention of external light interference are also highly required.

### SUMMARY OF THE INVENTION

An objective of the present invention is to provide a photoelectric chip array package structure that is convenient for installation and able to maintain high light intensity. The photoelectric chip array package structure of the present invention can be applied for an advertising sign or an electromagnetic detector. The present invention can be used to package illuminant components, such as LEDs, or optical sensors together with a substrate, and are cheap and high in quality.

For achieving the objective above, the present invention provides a photoelectric chip array package structure that has a substrate with side contacts or an external frame. The present invention can be made by using conventional manufacturing procedures and the peripheral manufacturing equipment of a low technical level.

The photoelectric chip-array package structure provided in the present invention includes a substrate having a front surface, a rear surface and a circuit disposed therein. Multiple photoelectric chips are disposed on the front surface of the substrate and connected to the circuit of the substrate. A package structure is made of a transparent material for light transmission and disposed on the substrate to cover the photoelectric chips. Multiple contacts are disposed at one side or multiple predetermined sides of the substrate, and connected to the circuit of the substrate.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a conventional photoelectric chip array package structure;

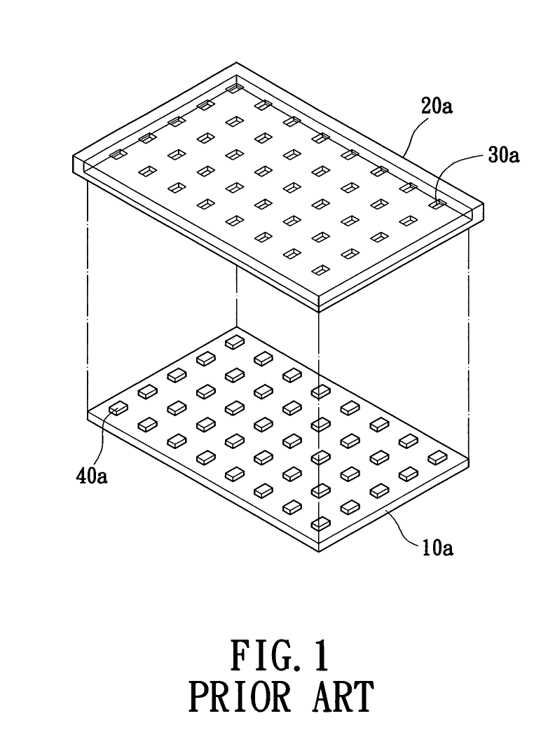

FIG. 2 is a diagram of photoelectric chip array package structure in accordance with an embodiment of the present invention; and

FIG. 3 is a diagram of photoelectric chip array package structure in accordance with another embodiment of the present invention.

### DETAILED DESCRIPTION OF PREFERRED EMBODIMENTS

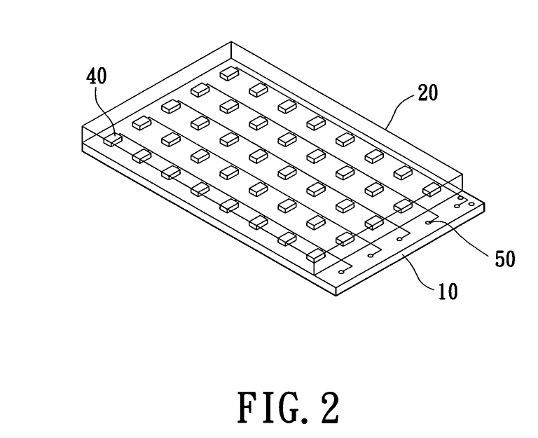

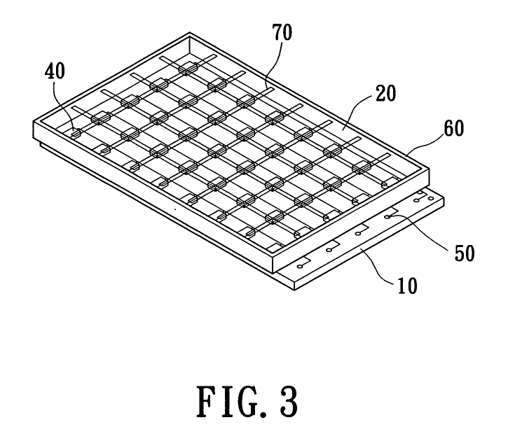

Reference is made to FIG. 2, which shows an embodiment of the present invention. The substrate 10 can have multiple layers. It has a front surface and a rear surface. The front surface is generally used for installation of photoelectric chips 40. The photoelectric chips 40 can be LEDs or optical sensors. The substrate 10 has a circuit disposed therein. A portion of the circuit is represented as the lines connecting the chips in FIG. 2, which can be considered a PCB-type circuit. The photoelectric chips 40, are installed on the front surface of the substrate 10 and connect to the circuit of the substrate 10. The package structure 20 is made of a transparent material for light transmission and is disposed above the substrate 10 to cover the photoelectric chips 40. Multiple contacts 50, which can connect to conductive lines so as to connect a circuit board installed at another side of the substrate 10, are disposed at one side or multiple predetermined sides of the substrate 10 and connected to the circuit of the substrate 10. The package structure 20 is transparent and can be made of a macromolecule material that is highly transmissive, such as resin. The main structure of the present invention is shown in FIG. 2 and FIG. 3.

Reference is made to FIG. 3. The embodiment of the present invention is described in detail as follows. The substrate 10 can be multi-layered. The photoelectric chips 40 can be LEDs or optical sensors. The package structure 20 can be made of a macromolecule material. The substrate 10 is rectangular and has multiple contacts 50. The contacts 50 can be disposed at one side or multiple predetermined sides of the substrate 10. The substrate 10 can be made of a copper circuit board. The contacts 50 can be disposed at the front side or rear side of the substrate 10. The package structure 20 can further have a reflective frame 60 surrounding the same to prevent external light interference and reflect internal light upward. The package structure 20 can have a processing portion 70. The processing portion 70 can be formed with optical gratings or optical filter films for filtering or processing light. The photoelectric chips 40 can be arranged in an array or a pattern, such as a trademark or an advertising sign.

The present invention has features as follows. The conventional BGA contacts of the photoelectric chip array package structure are replaced by the contacts disposed at one side or multiple predetermined sides of the substrate. The reflective flame 60 and processing portion 70, such as optical gratings or optical filter films used for filtering or processing light, are provided to improve airtightness, convenience for packaging and light-emitting intensity. In addition, the present invention is cheap and can be produced by slightly modifying the conventional packaging procedure of photoelectric chip arrays.

It should be noted that the mechanical equipment for making the side contacts, reflective flame 60 and the processing portion 70 are cheap and easily obtained. Thus, the present invention is easy to achieve. In addition, the substrate structure is robust and can enhance the light intensity thereof. Furthermore, the present invention can be made by slightly modifying the conventional packaging procedure, which means the conventional packaging procedure can still be used to manufacture the present invention after some of the conventional packaging machines are slightly modified. Thus, the present invention is practical.

The present invention has the following advantages:
(1) Installation of new manufacturing equipment is easy, and cost of the equipment and techniques needed are not high;
(2) Disposition of side contacts improves airtightness and convenience of installation;
(3) Most conventional packaging machines can still be used; and
(4) The light intensity is enhanced and the conventional packaging procedure is usable.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A photoelectric chip array package structure, comprising:
a substrate having a front surface, a rear surface, and a circuit disposed therein;
a plurality of photoelectric chips disposed on the front surface of the substrate and connected to the circuit of the substrate;
a package structure made of a transparent material for light transmission and disposed on the substrate to cover the photoelectric chips; and
a plurality of contacts disposed at one side or multiple predetermined sides of the substrate and connected to the circuit of the substrate.

2. The photoelectric chip array package structure as claimed in claim 1, wherein the substrate has multiple layers.

3. The photoelectric chip array package structure as claimed in claim 1, wherein the photoelectric chips are light-emitting diodes (LEDs) or optical sensors.

4. The photoelectric chip array package structure as claimed in claim 1, wherein the package structure is made of a macromolecule material.

5. The photoelectric chip array package structure as claimed in claim 1, wherein the substrate is rectangular, and the contacts are disposed at one side or multiple predetermined sides of the rectangular substrate.

6. The photoelectric chip array package structure as claimed in claim 1, wherein the substrate is made of a copper circuit board.

7. The photoelectric chip array package structure as claimed in claim 1, wherein the contacts are disposed on the front surface or the rear surface of the substrate.

8. The photoelectric chip array package structure as claimed in claim 1, wherein the package structure is surrounded by a reflective frame.

9. The photoelectric chip array package structure as claimed in claim 1, wherein the package structure has a processing portion.

10. The photoelectric chip array package structure as claimed in claim 9, wherein the processing portion of the package structure is an optical grating or an optical filter film.

11. The photoelectric chip array package structure as claimed in claim 1, wherein the photoelectric chips are arranged as an array or a pattern.
